(19) United States
(12) Patent Application Publication
(10) Pub. No.: US 2006/0169482 A1
(43) Pub. Date: Aug. 3, 2006

(54) Adhesive backed mount strip

(76) Inventors: Mark N. Hess, Woodstock, GA (US); Joseph Allen Dukes, Sugar Hill, GA (US)

Correspondence Address: PANDUIT CORP., LEGAL DEPARTMENT - TP12, 17301 SOUTH RIDGELAND AVENUE, TINLEY PARK, IL, 60477, US

(21) Appl. No.: 11/191,801

(22) Filed: Jul. 28, 2005

Related U.S. Application Data
(60) Provisional application No. 60/591,760, filed on Jul. 28, 2004.

(51) Int. Cl. H01B 7/00

(52) U.S. Cl. 174/135

(57) ABSTRACT

A mount strip for securing cables with cable ties comprises a top surface, a bottom surface opposite the top surface and first and second ends. The mount strip further comprises at least one cable tie receiving member extending outwardly from the top surface. The cable tie receiving member may be integrally formed in the top surface. The mount strip may further comprise first and second connectors at either end and a notch integrally formed within the top surface. The connectors may be used to link one mount strip to another and thereby increase length.

### CROSS-REFERENCE TO RELATED APPLICATIONS

This application claims priority to U.S. Provisional Application Ser. No. 60/591,760, filed Jul. 28, 2004, which is incorporated herein by reference.

### FIELD OF THE INVENTION

The present invention relates to an adhesive backed mount for securing a plurality of wires into a bundle with the use of cable ties to a surface and, more particularly, to an adhesive backed mount strip that provides a plurality of mounts for securing a plurality of wires into a bundle with the use of cable ties to a surface within close proximity of each other.

### BACKGROUND OF THE INVENTION

Typical adhesive backed mounts include a base with slots for receiving a cable tie from multiple directions. The adhesive backed mounts enable the user to install the cable ties on various surfaces without damaging the surface. It is often desirable to arrange the mounts so that the cable ties and wire bundles can be aligned and secured along the surface. Aligning the mounts can be difficult and time consuming depending on the surface. It would also be difficult to maintain the mounts in the specific aligned pattern. Thus, it is desirable to provide mounts that position and maintain cable ties and wire bundles in an aligned fashion. It is also desirable to provide mounts that are easy and efficient to install on various surfaces.

### SUMMARY OF THE INVENTION

The present invention concerns improved mount strips and mount strip assemblies comprising one or more cable tie receiving members.

In one embodiment, a mount strip for securing cables with a cable tie comprises a top surface, a bottom surface opposite the top surface and first and second ends. This embodiment further comprises at least one cable tie receiving member extending from the top surface and at least one of a first and second connector integrally formed at one of the first and second ends. The cable tie receiving member may comprise a surface spaced apart from the top surface with two or more support members positioned between and in contact with the surface and the top surface. The first connector may be male and the second connector female, or vice versa. Further, the connectors may mate with a third connector of a second mount strip to increase the length of the mount strip. The mount strip may also comprise an adhesive layer and a removable protective layer, the protective layer extending beyond the first or second end of the mount strip.

In a second embodiment, a mount strip for securing cables with a cable tie comprises a top surface, a bottom surface opposite the top surface and first and second ends. This embodiment further comprises two or more cable tie receiving members extending from the top surface and a notch integrally formed between the two or more cable tie receiving members. The notch, formed in the top or bottom surface, may be “V” shaped. An adhesive layer secured to the bottom surface may include a cut portion below the notch.

In a third embodiment, a mount strip for securing cables with a cable tie comprises a top surface, a bottom surface and first and second ends. This embodiment further comprises at least one cable tie receiving member extending from the top surface, wherein the at least one cable tie receiving member is integrally formed with the top surface. The mount strip may further comprise a recess defined in the top surface underlying the cable tie receiving member. In addition, the mount strip may comprise an opening adapted to receive a fastener, the opening being positioned between two cable tie receiving members.

In a fourth embodiment, a cable tie mounting assembly comprises a first mount strip comprising two or more cable tie receiving members, a second mount strip comprising two or more cable tie receiving members and a connector at one end, the connector adapted to secure the first mount strip to the second mount strip. The connectors may be male or female and the cable tie receiving member may exhibit the configuration discussed above in connection with the first embodiment.

### BRIEF DESCRIPTION OF FIGURES

The features and advantages of this invention will become apparent from the following description of preferred embodiments with reference to the accompanying drawings, wherein:

FIG. 1 is a front perspective view of the adhesive backed mount strip of the present invention;

FIG. 2 is an enlarged perspective view of the molded V-notch in the adhesive backed mount strip of FIG. 1;

FIG. 3 is a top view of the adhesive backed mount strip of FIG. 1;

FIG. 4 is a side elevational view of the adhesive backed mount strip of FIG. 1;

FIG. 5 is a front perspective view of two adhesive backed mount strips of the present invention connected to one other; and

FIG. 6 is a cross-sectional view taken along lines 6-6 of FIG. 5.

### DETAILED DESCRIPTION OF PREFERRED EMBODIMENTS

FIG. 1 illustrates the adhesive backed mount strip 10 of the present invention. The mount strip 10 is an integrally molded strip that includes a top surface 12, a bottom surface 14 and end surfaces 16.

Cable tie bridges 20, referred to alternatively as cable tie receiving members, are molded such that each bridge extends from the top surface 12 of the mount strip. As seen in FIGS. 1-3, cable tie bridges 20 include a raised central flat surface 22 that is supported by a plurality of support members 24 positioned at each corner of the flat surface 22. As used herein, the term cable tie receiving member means a surface 22 spaced apart from the top surface 12 and comprising support members 24 that contact the top surface 12. Support members 24 define cable tie windows 26 located below the central flat surface 22, through which a portion of a cable tie may be passed. The cable tie windows 26 are designed to receive a cable tie or strap. The cable tie windows 26 enable the user to orient the cable ties in various positions when securing the cable ties to the mount strip. As illustrated in FIG. 1, the mount strip preferably includes four cable tie bridges. It is contemplated, however, that the number and the size of the cable tie bridges could vary depending on the end user's specifications.

Referring to FIG. 4, the bottom surface 14 of the mount strip 10 includes a pressure sensitive foam adhesive layer 30 and a protective liner 32. The protective liner 32 extends beyond the ends 16 of the mount strip to create tear tabs 34. Since a tear tab 34 is located at each end 16 of the mount strip 10, the protective liner 32 may be conveniently removed from either end 16 of the mount strip 10.

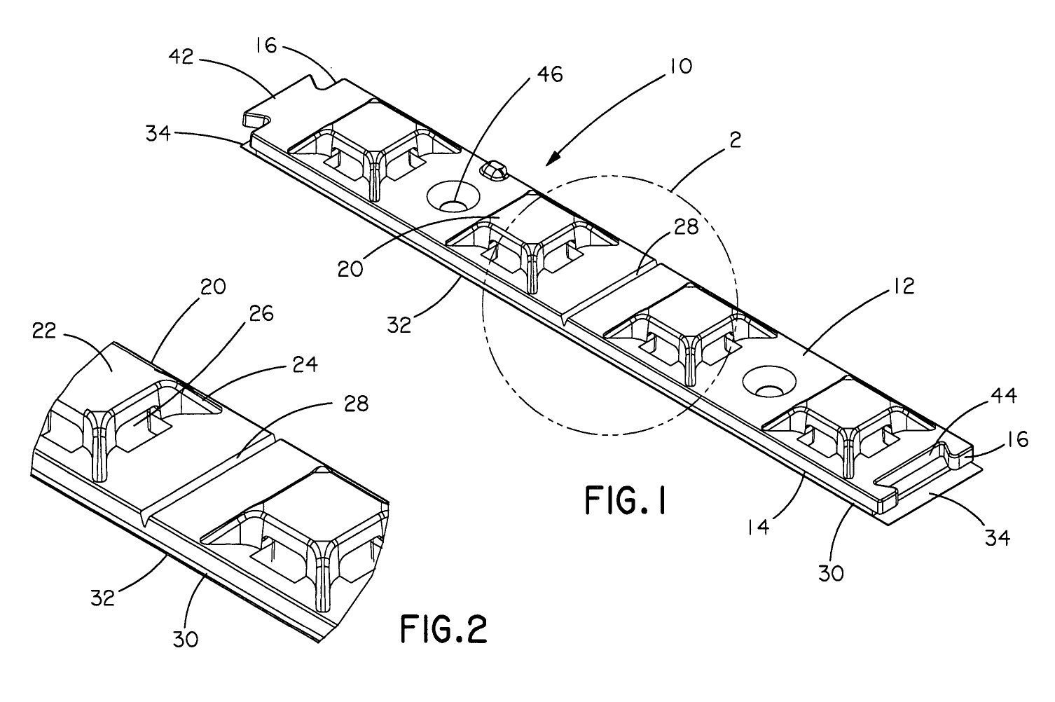

As shown in FIGS. 1 and 2, the top surface 12 of the mount strip 10 also includes a molded V-notch 28. The V-notch 28 is preferably positioned at the middle of the mount strip 10 with two cable tie bridges 20 on either side of the V-notch 28. During installation, it may be necessary to divide the mount strip from a four bridge mount strip to a two bridge mount strip when four bridges are not required. Since the thickness of the molded mount strip is reduced at the V-notch 28, the user may easily snap off or break away two of the bridges from the four bridge mount strip. Thus, the molded V-notch 28 provides the user with a controlled and easy means for dividing the mount strip.

Additionally, at the V-notch 28, the adhesive layer 30 along the bottom surface 14 is “kiss cut” so that when the mount strip 10 is divided at the V-notch 28 the adhesive layer 30 will easily separate. Also, since a tear tab 34 is located at each end 16 of the mount strip 10, each half of the divided mount strip will include a tear tab 34 to facilitate removal of the protective liner 32 before mounting on the desired surface.

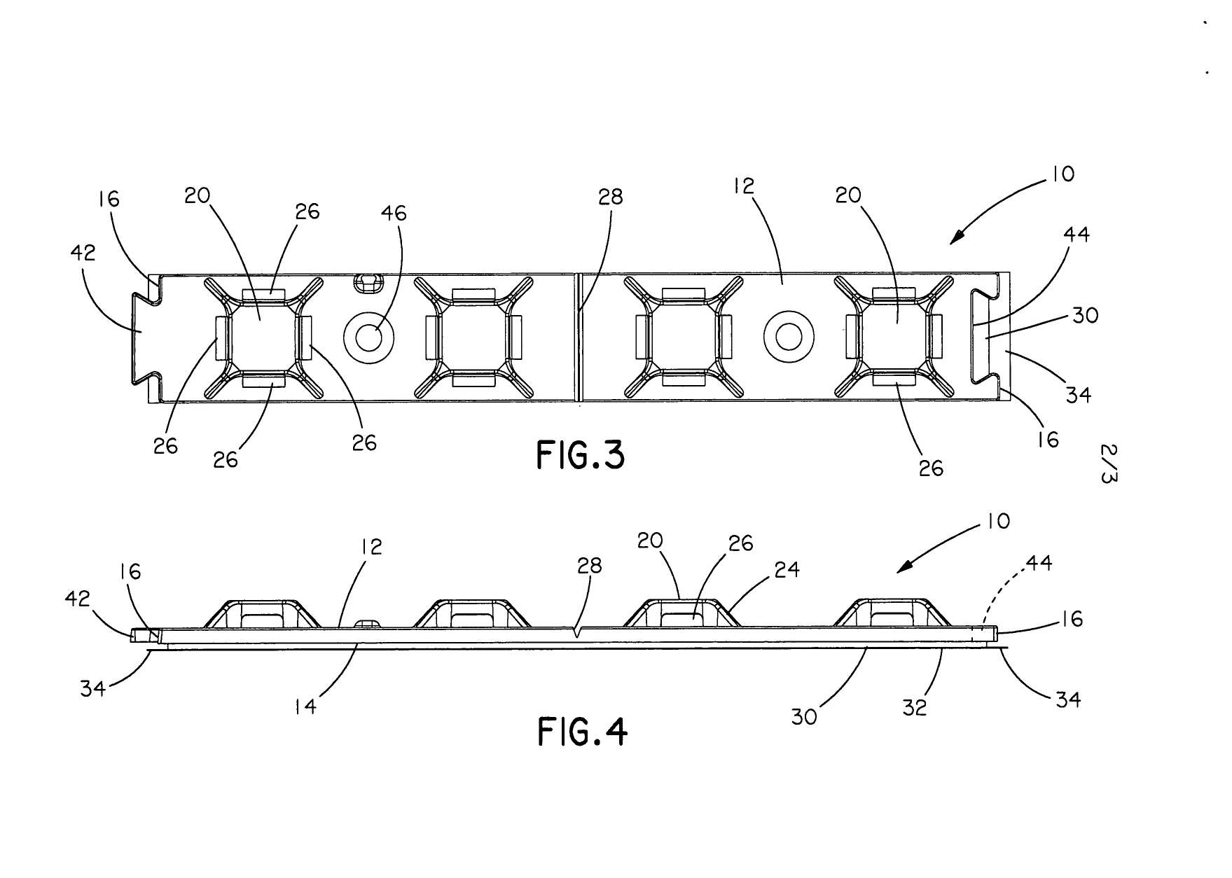

The ends 16 of the mount strip 10 include connectors that are molded with the strip. More specifically, as shown in FIGS. 1 and 3, the ends 16 include dovetail connectors where one end of the mount strip includes a male dovetail 42 and the opposite end of the mount strip includes a female dovetail 44. Although the mount strip of the present invention is illustrated with dovetail connectors, the ends 16 may be molded with other connectors formed from various mating shapes.

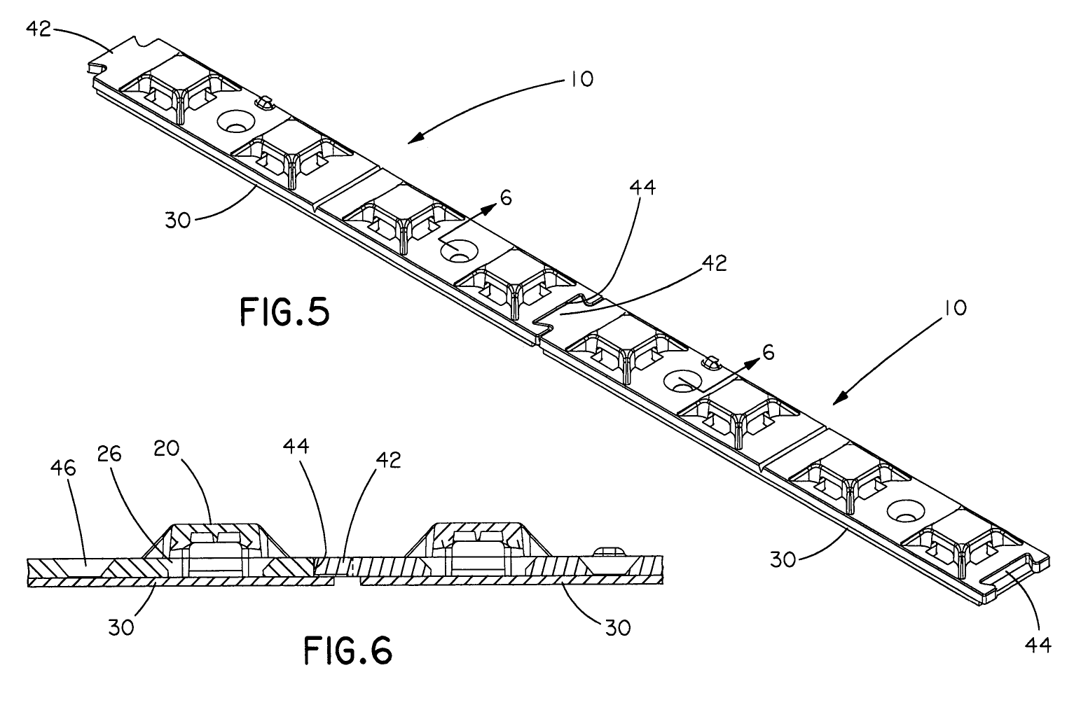

As shown in FIGS. 5 and 6, the dovetail connectors enable the user to link adjacent mount strips. As a result, the user is able to increase the length of the mount strip when it is desirable to position and align a plurality of cable ties in proximity to each other.

If desired, the mount strip of the present invention may also be molded with a number of holes 46 for receiving screws to secure the mount strip to a surface.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the prior art.

1. A mount strip for securing cables with a cable tie, the mount strip comprising:
a top surface, a bottom surface opposite the top surface and first and second ends;
at least one cable tie receiving member extending from the top surface; and
at least one of a first and second connector integrally formed at one of the first and second ends.

2. The mount strip of claim 1, wherein the first connector is male and the second connector is female.

3. The mount strip of claim 1, wherein one of the first and second connectors of the mount strip mates with a third connector of a second mount strip to increase the length of the mount strip.

4. The mount strip of claim 1, further comprising an adhesive layer secured to the bottom surface and a removable protective liner positioned on the adhesive layer.

5. The mount strip of claim 4, wherein the protective liner extends beyond the first or second end of the mount strip.

6. The mount strip of claim 1, further comprising a notch defined in the top surface and positioned between two cable tie receiving members.

7. The mount strip of claim 1, in which the cable tie receiving member comprises a surface spaced apart from said top surface with two or more support members positioned between and in contact with the surface and the top surface.

8. A mount strip for securing cables with a cable tie, the mount strip comprising:
a top surface, a bottom surface opposite the top surface and first and second ends;
two or more cable tie receiving members extending from the top surface; and
a notch integrally formed between the two or more cable tie receiving members.

9. The mount strip of claim 8, wherein the notch is “V” shaped.

10. The mount strip of claim 8, wherein the notch is formed in the top surface.

11. The mount strip of claim 8, further comprising an adhesive layer secured to the bottom surface.

12. The mount strip of claim 11, further including a cut portion positioned on the adhesive layer positioned below the notch.

13. The mount strip of claim 8, further comprising a first end including one of a female and a male connector integrally formed with the strip, wherein the female or male connector of the mount strip mates with a female or male connector of a second mount strip.

14. The mount strip of claim 8, in which the cable tie receiving member comprises a surface spaced apart from said top surface with two or more support members positioned between and in contact with the surface and the top surface.

15. A mount strip for securing cables with a cable tie, the mount strip comprising:
a top surface, a bottom surface opposite the top surface and first and second ends;
at least one cable tie receiving member extending from the top surface, wherein the at least one cable tie receiving member is integrally formed with the top surface.

16. The mount strip of claim 15, further comprising a recess defined in the top surface underlying the cable tie receiving member.

17. The mount strip of claim 15, wherein the bottom surface comprises an adhesive.

18. The mount strip of claim 15, further comprising a notch defined in the top surface and positioned between two cable tie receiving members.

19. The mount strip of claim 15, further comprising an opening defined in the strip adapted to receive a fastener, the opening being positioned between two cable tie receiving members.

20. A cable tie mounting assembly comprising:
a first mount strip comprising two or more cable tie receiving members;
a second mount strip comprising two or more cable tie receiving members and a connector at one end, the connector adapted to secure the first mount strip to the second mount strip.

21. The assembly of claim 20, wherein the two or more cable tie receiving members of the first mount strip are aligned with the two or more cable tie receiving members of the second mount strip with the first and second mount strips connected together.

22. The assembly of claim 20, wherein the connector is one of a female and a male connector.
